(19) United States
(12) Patent Application Publication
(10) Pub. No.: US 2015/0281474 A1
(43) Pub. Date: Oct. 1, 2015

(54) Cloud Multi-Function Printer and Cloud Multi-Function Printer Service System

(71) Applicant: AVISION Inc., Hsinchu (TW)

(72) Inventor: Chen-Chang Li, Hsinchu (TW)

(21) Appl. No.: 14/305,744

(22) Filed: Jun. 16, 2014

(30) Foreign Application Priority Data
Mar. 31, 2014 (TW) 103112036

(51) Int. Cl. H04N 1/00; H04N 1/32; G06F 3/12

(52) U.S. Cl. CPC H04N 1/00244; G06F 3/1267; G06F 3/1243; H04N 1/32133; H04N 2201/0094; H04N 2201/3269

(57) ABSTRACT

A cloud multi-function printer and a cloud multi-function printer service system. The cloud multi-function printer service system includes an electronic apparatus and a cloud multi-function printer. The electronic apparatus includes a first electronic document and displays a printing interface to be applied to input a cloud path for the first electronic document to be stored on a cloud server. The first electronic document can be uploaded to the cloud server via the cloud path by the first electronic apparatus. A printing command containing the cloud path and the first electronic document is also output by the first electronic apparatus. The cloud multi-function printer comprises a first transmitting unit configured for receiving the printing command and a printer unit for printing a paper document and an identification code corresponding to the cloud path on the paper document.

### CROSS-REFERENCE TO RELATED APPLICATION

This application claims the benefit of Taiwan Patent Application No. 103112036, filed on Mar. 31, 2014, in the Taiwan Intellectual Property Office, the disclosure of which is incorporated herein in its entirety by reference.

### BACKGROUND OF THE INVENTION

1. Field of the Invention

The present disclosure is related to a cloud multi-function printer and a cloud multi-function printer service system, more particularly, to a cloud multi-function printer service system capable of printing a cloud path of an electric document stored in a cloud server on a printed paper document.

2. Description of the Related Art

At present, a business machine can provide multiple functions of printing, scanning, and copying for user. A computer is usually connected to this business machine. A user can transmit a printing command to the business machine by the computer to print an electric document for further paper reading. Besides, the business machine can be used to scan a paper document and then upload a picture file generated by scanning to a cloud server. The user can download the picture file by operating the computer for further application. However, there are some drawbacks of operating in such a way.

First, an aspect of environmental protection is not considered when operating in such a way. For example, in office meeting, everyone holds the same paper documents being printed the meeting material for discussion, but most of these paper documents are discarded after meeting. This results in paper consumption.

Second, it is not convenient to share the electric document. If the user who receives the printed paper document wants the original electric document for further reading or amendment, he/her must ask for the owner by, for example, exchanging email box or inquiring a download address for the file. However, it may be a heavy load for the owner if all persons joining the meeting ask for the electric document one by one.

Thirdly, the traditional function of uploading file of the business machine lacks flexibility. When the traditional business machine is connected the computer, the electric document can be uploaded to an assigned cloud server by the computer, but not by the business machine. However, when not being connected to the computer, the business machine only can upload the electric document to a predetermined network space, but not any cloud server.

### SUMMARY OF THE INVENTION

An aspect of embodiment according to the present disclosure directs to provide a cloud multi-function printer and a cloud multi-function printer service system which can print an identification code of the network path of the original electric document on the printed paper document, so that other person can download the original electric document to a personal computer or a tablet computer according to the network path. Therefore, the cost of printing paper can be minimized efficiently by reducing to print the same paper.

An aspect of embodiment according to the present disclosure directs to provide a cloud multi-function printer and a cloud multi-function printer service system which can print an identification code of the network path of the original electric document on the printed paper document, so that other persons can amend the original electric document directly according to the network path. Therefore, the original electric document can be shared efficiently.

An aspect of embodiment according to the present disclosure directs to provide a cloud multi-function printer and a cloud multi-function printer service system, a folder on the cloud server can be created automatically according to a date, a user name or an attribute of scanned document for better and easier file management.

An aspect of embodiment according to the present disclosure directs to provide a cloud multi-function printer and a cloud multi-function printer service system which create a folder on the cloud server automatically according to user's attribute for protecting privacy of user.

An aspect of the embodiment according to the present disclosure directs to provide a cloud multi-function printer and a cloud multi-function printer service system, a cloud path of the folder for storing the original electric document is generated by the cloud multi-function printer or a computer connected with the cloud multi-function printer, so the cloud multi-function printer can provide multiple approaches to upload original electric document.

An exemplary embodiment of the present disclosure provides a cloud multi-function printer service system comprising a first electronic apparatus and a cloud multi-function printer. The first electronic apparatus comprises a first electronic document and displays a printing interface configured for inputting a cloud path indicating where the first electronic document is stored on a cloud server. The first electronic apparatus uploads the first electric document to the cloud server via the cloud path, and outputs a printing command containing the cloud path and the first electronic document. The cloud multi-function printer comprises a first transmitting unit configured for receiving the printing command, and a printing unit configured for printing a first paper document according to the first electric document and printing an identification code corresponding to the cloud path on the first paper document.

Preferably, the cloud multi-function printer further comprises a scan input unit configured for scanning a second paper document to generate the second electric document.

Preferably, the cloud multi-function printer further comprises a second transmitting unit configured for transmitting the second electric document to the first electronic apparatus or the cloud server automatically.

Preferably, the identification code comprises a QR-Code, a website address or a barcode.

Preferably, the cloud multi-function printer service system according to the present disclosure further comprises a second electronic apparatus. The second electronic apparatus uses an image capturing unit or a sensing unit to scan the identification code for downloading the first electric document, or for displaying a stored position of the first electric document in the cloud server on a screen of the second electronic apparatus.

An exemplary embodiment of the present disclosure provides further provides a cloud multi-function printer comprising a first transmitting unit, a second transmitting unit and a printing unit. The first transmitting unit is configured for receiving a printing command containing a first electric document. A second transmitting unit is configured for connecting a cloud server and generating a cloud path automatically. The second transmitting unit uploads the first electric document to the cloud server according to the cloud path. The printing unit is configured for printing a first paper document according to the first electric document and printing an identification code corresponding to the cloud path on the first paper document.

Preferably, the cloud multi-function printer according to the present disclosure further comprises a scan input unit configured for scanning a second paper document to generate the second electric document.

Preferably, the second transmitting unit transmits the second electric document to the cloud server automatically.

Preferably, the identification code comprises a QR-Code, a website address or a barcode.

Preferably, the cloud multi-function printer creates a folder automatically on the cloud server according to a date, a user name or a document attribute.

An exemplary embodiment of the present disclosure provides a cloud multi-function printer comprising a first transmitting unit, a second transmitting unit and a printing unit. The first transmitting unit is configured for receiving a printing command from the first electronic apparatus. The printing command contains a cloud path and a first electric document. The second transmitting unit is configured for connecting the cloud server, and uploading the first electric document to the cloud server according to the cloud path. The printing unit is configured for printing a first paper document according to the first electric document and printing an identification code corresponding to the cloud path on the first paper document.

Preferably, the cloud multi-function printer according to the present disclosure further comprises a scan input unit configured for scanning a second paper document to generate the second electric document.

Preferably, the first transmitting unit or the second transmitting unit transmits a second electric document to the first electronic apparatus or the cloud server automatically.

Preferably, the identification code comprises a QR-Code, a website address or a barcode.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a block diagram of an embodiment of a cloud multi-function printer service system according to the present disclosure.

FIG. 2 is a first schematic view of another embodiment of the cloud multi-function printer service system according to the present disclosure.

FIG. 3 is a second schematic view of another embodiment of the cloud multi-function printer service system according to the present disclosure.

FIG. 4 is a block diagram of a second embodiment of a cloud multi-function printer according to the present disclosure.

FIG. 5 is a schematic view of a third embodiment of the cloud multi-function printer according to the present disclosure.

FIG. 6 is a block diagram of a fourth embodiment of the cloud multi-function printer according to the present disclosure.

FIG. 7 is a schematic view of a fifth embodiment of the cloud multi-function printer according to the present disclosure.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

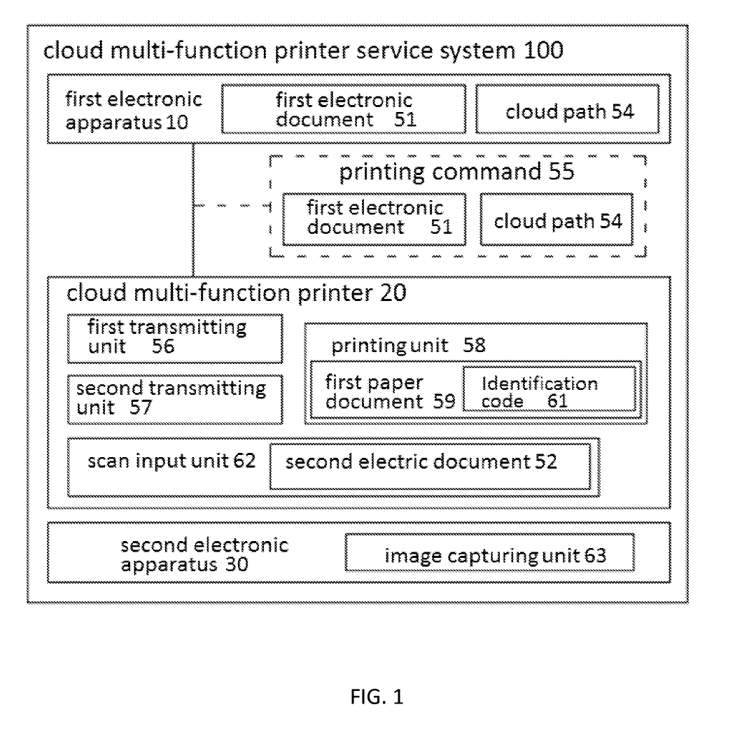

Please refer to FIG. 1 which is a block diagram of an embodiment of a cloud multi-function printer service system according to the present disclosure. In FIG. 1, a cloud multi-function printer service system 100 comprises a first electronic apparatus 10, second electronic apparatus 30 and a cloud multi-function printer 20. In implementation, the first electronic apparatus 10 or the second electronic apparatus 30 is a computer, a tablet computer or a laptop computer, and the cloud multi-function printer 20 is a business machine having a network transmission function, a printing function, a copy function or a scanning function.

The first electronic apparatus 10 comprises a first electronic document 51 and a screen, and a printing interface is displayed on the screen to be applied to input a cloud path 54 for the first electronic document 51 to be stored on a cloud server 53. The first electronic apparatus 10 uploads the first electric document 51 to the cloud server 53 via the cloud path 54, and outputs a printing command 55 containing the cloud path 54 and the first electronic document 51 to the cloud multi-function printer 20. Preferably, the first electric document 51 comprises a document file generated by an application program, such as the file with extension doc, docx, xls or txt.

The cloud multi-function printer 20 comprises a first transmitting unit 56, a second transmitting unit 57, a printing unit 58 and a scan input unit 62. The first transmitting unit 56 comprises a network transmission module or an USB interface configured for receiving the printing command 55 of the first electronic apparatus 10. The printing unit 58 prints a first paper document 59 according to the first electric document 51 and prints an identification code 61 corresponding to the cloud path 54 on the first paper document 59. In implementation, the identification code 61 comprises a QR-Code, a website address or a barcode. The scan input unit 62 is configured for scanning a second paper document to generate a second electric document 52, and the second transmitting unit 57 transmits the second electric document 52 to the first electronic apparatus 10 or the cloud server 53 automatically.

The second electronic apparatus 30 comprises an image capturing unit 63 or a sensing unit. The image capturing unit 63 is used to scan the identification code 61 on the first paper document 59 to obtain the cloud path 54. The second electronic apparatus 30 then downloads the first electric document 51 according to the cloud path 54, or displays stored position of the first electric document 51 in the cloud server 53 on a screen of the second electronic apparatus 30 for subsequent access.

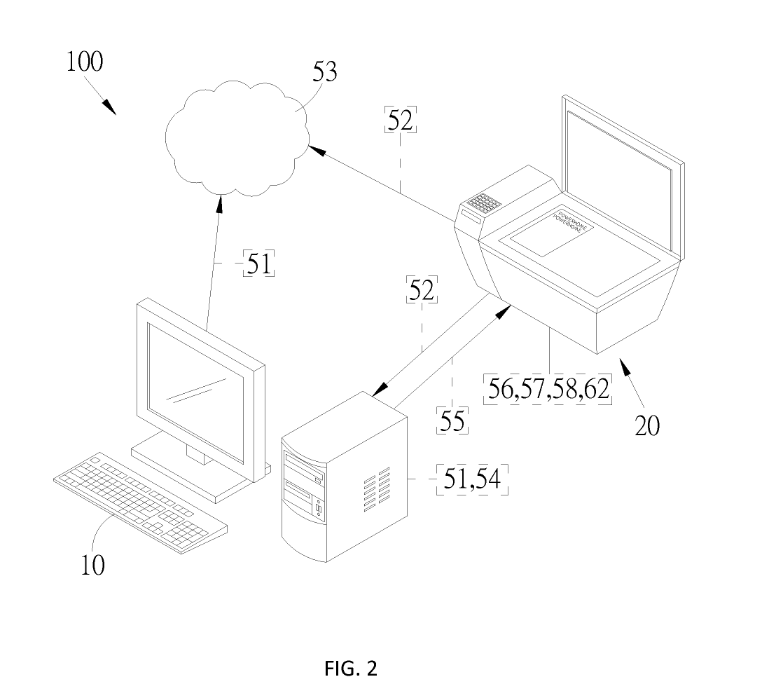

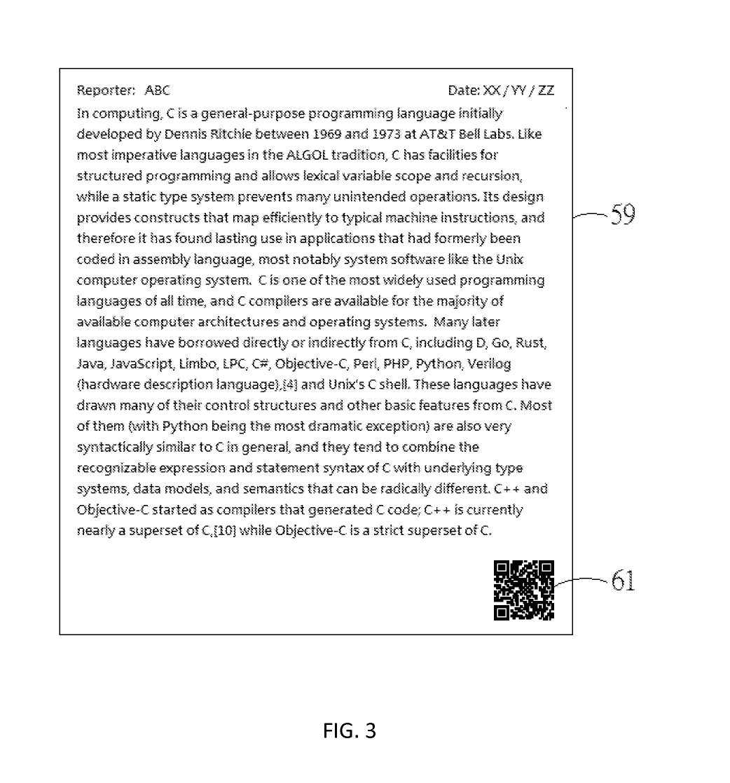

Please refer to FIG. 2 and FIG. 3 which are a first schematic view and a second schematic view of another embodiment of the cloud multi-function printer service system according to the present disclosure. As shown in FIG. 2, by the cloud multi-function printer service system 100, user can upload a first electric document 51 to a cloud server 53, and record the cloud path 54 where the first electric document 51 stored in the cloud server 53 for sharing. When the user desires to print the first electric document 51, the first electronic apparatus 10 transmits a printing command 55 containing the first electric document 51 and the cloud path 54, to the cloud multi-function printer 20.

In this case, after the first transmitting unit 56 of the cloud multi-function printer 20 receives the printing command 55, the printing unit 58 prints the first paper document 59 according to the first electric document 51 and prints an identification code 61 on the first paper document 59. In implementation, the identification code 61 comprises a QR code indicative of the cloud path 54, as shown in FIG. 3. Other persons can use an image capturing unit 63 of a tablet computer or cell phone to scan the QR code on the first paper document 59, to access the origin file of the first electric document 51. Therefore, the first electric document 51 can be shared more conveniently.

The scan input unit 62 of the cloud multi-function printer 20 can be used to scan a second paper document to generate a second electric document 52, and then the second transmitting unit 57 transmits the second electric document 52 to the cloud server 53 automatically, or the first transmitting unit 56 transmits the second electric document 52 to the first electronic apparatus 10 automatically.

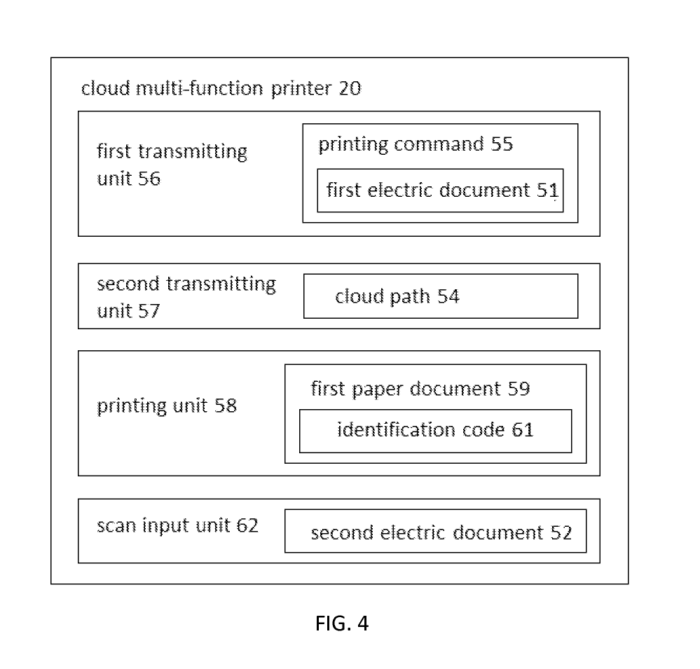

Please refer to FIG. 4 which is a block diagram of a second embodiment of a cloud multi-function printer according to the present disclosure. As shown in FIG. 4, the cloud multi-function printer 20 comprises a first transmitting unit 56, a second transmitting unit 57, a printing unit 58 and a scan input unit 62. The first transmitting unit 56 receives the printing command 55 containing a first electric document 51. The second transmitting unit 57 is connected to the cloud server 53 and generates a cloud path 54 automatically. The second transmitting unit 57 then uploads the first electric document 51 to the cloud server 53 according to the cloud path 54. The functions of the printing unit 58 and the scan input unit 62 are the same as that of FIG. 1, so their detail descriptions are omitted.

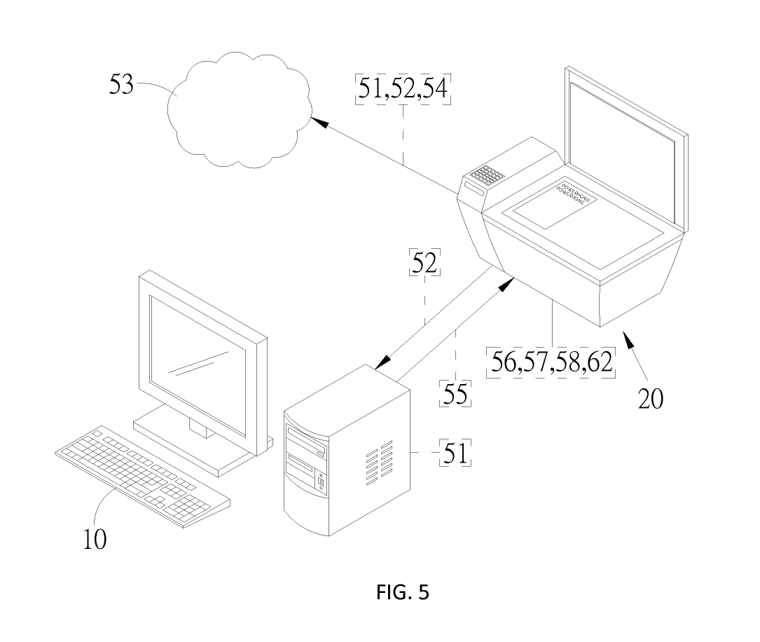

Please refer to FIG. 5 which is a schematic view of a third embodiment of a cloud multi-function printer according to the present disclosure. As shown in FIG. 5, the difference between this embodiment and the second embodiment is that the printing command 55 outputted from the first electronic apparatus 10 just comprises a first electric document 51, and the first electric document 51 is uploaded to the cloud server 53 by the cloud multi-function printer 20, not by the first electronic apparatus 10. The cloud path 54 for uploading first electric document 51 to the cloud server 53 is determined by the cloud multi-function printer 20. The main functions of the first transmitting unit 56, the second transmitting unit 57, the printing unit 58 and the scan input unit 62 are the same as that of the second embodiment, so their detail descriptions are omitted.

In more detail, for transmitting the first electric document 51 to the cloud server 53, the cloud multi-function printer 20 can create a folder in the cloud server 53 according to a date, a user name, a department or a document attribute. For example, most internal documents of company have the same format, so the department title or user ID is generally displayed on the same position of these documents. In this case, when the document is scanned, an OCR manner can be performed on the regular region to obtain the content, and the content is used as the title of the folder created in the cloud server 53. Therefore, the cloud multi-function printer 20 can upload the electric document to a corresponding folder in the cloud server 53 according to the documentary attribute.

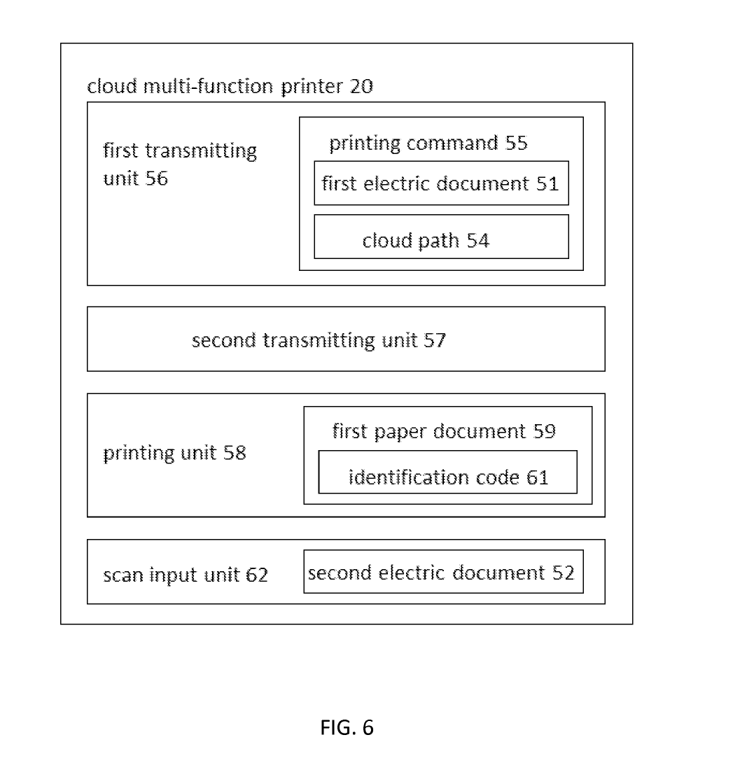

Please refer to FIG. 6 which is a block diagram of a fourth embodiment of the cloud multi-function printer according to the present disclosure. The cloud multi-function printer 20 comprises a first transmitting unit 56, a second transmitting unit 57, a printing unit 58 and a scan input unit 62. The first transmitting unit 56 receives printing command 55 from the first electronic apparatus 10. The printing command 55 contains a cloud path 54 and a first electric document 51. The second transmitting unit 57 is connected the cloud server 53 and uploads the first electric document 51 to the cloud server 53 according to the cloud path 54. The functions of the printing unit 58 and the scan input unit 62 are the same as that of FIG. 1, so their detail descriptions are omitted.

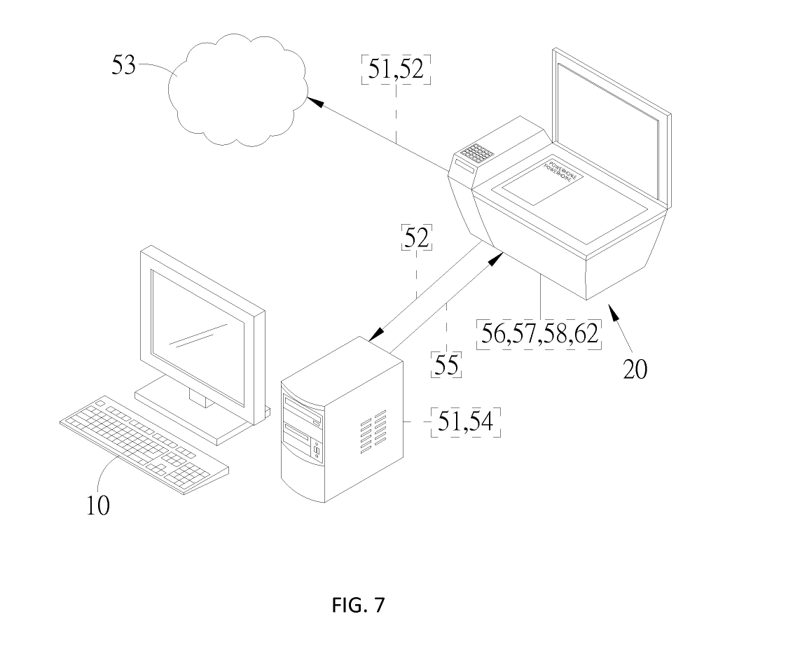

Please refer to FIG. 7 which is a schematic view of a fifth embodiment of a cloud multi-function printer according to the present disclosure. The difference between this embodiment and the above-mentioned embodiments is that the printing command 55 generated by the first electronic apparatus 10 contains a first electric document 51 and a cloud path 54 which is determined by the first electronic apparatus 10, and the cloud multi-function printer 20 upload the first electric document 51 to a folder of the cloud server 53 according to the cloud path 54. The main functions of the first transmitting unit 56, the second transmitting unit 57, the printing unit 58 and the scan input unit 62 are the same as that of the third embodiment, so their detail descriptions are omitted.

In summary, the cloud multi-function printer and a cloud multi-function printer service system according to the present disclosure can print an identification code of the network path of the original electric document on the printed paper document, so that other persons can download the original electric document to personal computer or tablet computer according to the network path. Therefore, the cost of printing paper can be reduced efficiently. Besides, other users can also amend the original electric document according to network path, so the original electric document can be shared efficiently. Moreover, the cloud multi-function printer can create a folder on the cloud server automatically according to date, user name or attribute of scanned document, so as to provide easier scanned document management and protect user's privacy.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1-5. (canceled)

6. A printer, comprising:
a first transmitting unit, configured for receiving a printing command containing a first electronic document;
a second transmitting unit, configured for connecting a cloud server and generating a cloud path automatically, and uploading the first electronic document to the cloud server according to the cloud path; and
a printing unit, configured for printing a first paper document according to the first electronic document and printing an identification code corresponding to the cloud path on the first paper document.

7. The printer according to claim 6, further comprising a scan input unit configured for scanning a second paper document to generate a second electronic document.

8. The printer according to claim 7, wherein a second transmitting unit transmits the second electronic document to the cloud server automatically.

9. The printer according to claim 6, wherein the identification code comprises a QR-Code, a website address or a barcode.

10. The printer according to claim 6, wherein the cloud multi-function printer creates a folder automatically on the cloud server according to date, user name or document attributes.

11-14. (canceled)
